(19) United States
(12) Patent Application Publication
(10) Pub. No.: US 2010/0131434 A1
(43) Pub. Date: May 27, 2010

(54) AUTOMATED PATIENT-MANAGEMENT SYSTEM FOR PRESENTING PATIENT-HEALTH DATA TO CLINICIANS, AND METHODS OF OPERATION THEREOR

(75) Inventors: Michael Andrew Magent, Allentown, PA (US); Sean Michael Nevins, Bryn Mawr, PA (US); Steven Michael Paris, Fleetwood, PA (US); Michael S. Toth, Allentown, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: Air Products and Chemicals, Inc., Allentown, PA (US)

(21) Appl. No.: 12/276,460

(22) Filed: Nov. 24, 2008

(51) Int. Cl. G06F 3/048; G06Q 50/00; G06F 15/18; G06N 5/02

(52) U.S. Cl. 706/11; 705/3; 706/14; 706/46

(57) ABSTRACT

An automated patient-management system for efficiently reporting patient information to clinicians, and a method of operation thereof is described. The system automatically collects and analyzes historic-physiologic data indicative of a patient's health from a myriad of sources. Based on the historic-physiologic data, the system automatically generates a health-risk score indicative of whether a patient will experience a serious-medical event in the near future (e.g., a predetermined time interval). The system uses a processing model that may rely on Hierarchical-Temporal Memory techniques and other models, for extracting and analyzing patient data. The system also generates an integrated synopsis of a patient's health condition, including the health-risk score. The synopsis is then presented (served) to a clinician in an organized, simplified, and effective manner via a client-side user interface. The synopsis enables a physician to proficiently grasp the patient's most critical health parameters in a short period of time.

### COPYRIGHT NOTICE

Contained herein is material that is subject to copyright protection. The copyright owner has no objection to facsimile reproduction of the patent disclosure by any person as it appears in the United States Patent and Trademark Office, but otherwise reserves all rights to the copyright. Copyright 2008. Air Products and Chemicals Inc.

### BACKGROUND OF THE INVENTION

The present invention relates to an automatic system and method for analyzing, and presenting an integrated view of a patient's health status to clinicians. In particular, the present invention is directed to an automated system and method for integrating and analyzing historic data indicative of a patient's health, determining a risk factor that a patient will experience an adverse-health event within a predetermined period of time based on the assessment, and presenting the risk factor, along with an integrated synopsis of the patient's health status to clinicians in a simplified, but effective manner.

There is a drive today to store health data in an electronic format in a central repository. This will enable, pharmacies, hospitals, healthcare providers, health insurers, and patients to have access to a patient's health information from a single source. Another potential benefit is for healthcare providers to make informed healthcare decisions when caring for patients, as the patient's record will be more complete, and not scattered among different sites that often do not share health information.

The focus of these efforts is on centralizing, securing, and permitting access to the health records, including converting health data from paper to electronic formats. The belief is that by computerizing and centralizing records, the quality of care will improve for patients.

One of the toughest hurdles, though, is that there is no real economic incentive to digitize data. Paying for the systems to handle and store medical data, not to mention training health providers to use the systems, is extremely costly. So, many healthcare providers and hospitals are resistant to invest in electronic-medical-record systems. The amount of time needed to train and switch over to these systems is often viewed as too much trouble for time-stressed clinicians. Additionally, any improvements provided by these systems are often outweighed by confusing, unfriendly, and cumbersome graphical-user interfaces. Thus, many electronic systems in use in healthcare-provider offices today are primarily delegated to handling billing functions, or for scheduling of appointments.

So, there is a paradox in medicine today: despite high-tech medical systems, even electronic-medical-record systems, many healthcare providers continue to collect and record data in paper format, which are often maintained in chronological order. In a time-stressed environment, the clinician may fail to appreciate trends or recognize subtle changes in a patient's health using this hodgepodge of electronic and paper records.

Also, when a patient leaves the clinician's office, rarely does the clinician have the time or resources to follow-up with the patient to track and monitor the patient's condition. So, the conventional methodology of waiting for a patient to contact the healthcare provider when a health episode occurs appears to be the way in which most healthcare providers treat patients regardless of whether the health records are in electronic format or centralized.

As a result of the foregoing, managing, and providing health care to patients today remains largely reactionary, inconsistent, and costly.

### BRIEF SUMMARY OF THE INVENTION

An automated patient-management system for efficiently reporting patient information to clinicians, and a method of operation thereof is described. Such a system automatically collects and analyzes historic-physiologic data indicative of a patient's health from a myriad of sources. Based on the historic-physiologic data, the system automatically generates a health-risk score indicative of whether a patient will experience a serious-medical event in the near future (e.g., a predetermined time interval). The system uses a processing model that may rely on Hierarchical-Temporal Memory techniques, among other models, for extracting and analyzing patient data. The system also generates an integrated synopsis of a patient's health condition, including the health-risk score. The synopsis is then presented to a clinician in an organized, simplified, and effective manner, such as via a client-side user interface. The synopsis enables a physician to proficiently grasp the patient's most critical health parameters in short order.

Thus, the automated patient-management system presents data in a more effective manner. The system also assists the healthcare provider in a proactive manner, by automatically notifying the healthcare provider of patients with elevated health-risk scores indicating that the patient will experience a serious-medical event in the near future. So, the clinician is able to reach out to the patient in a preventative manner before the serious-medical event occurs, rather than having to react to the patient after the patient experiences the serious-medical event. In other words, the prediction allows an intervention before a costly and dangerous hospitalization, etc.

In one embodiment, the patient-management system includes a backend and a front end. The backend of the system automatically tracks health status information about a patient, and predicts whether the patient will experience a serious-medical event within a predetermined time period. The front-end of the system presents health-status information about a patient to users of the system, including the prediction a serious-medical event.

Referring initially to the backend, the patient-management system collects physiologic data about a patient (e.g. “patient data”) acquired in electronic format from many different sources. For instance, by way of illustration and not limitation, patient data may be collected from pharmaceutical, hospital, insurance, and clinician databases. The patient data may include relevant information about the patient, such as illnesses, allergies, medications, symptoms, diagnostic reports, device data (e.g. implantable devices, EGK, etc.), laboratory results, test results, clinician notes, age, gender, ethnicity information, hospitalizations, and any other health-relevant information.

The patient data is extracted, normalized, and saved in a staging database. The normalized data is then and analyzed by a processing model. In one embodiment, the processing model includes a Hierarchical-Temporal Memory (HTM) model configured to analyze data using a collection of nodes arranged in a hierarchy. Each node in the hierarchy self-discovers a set of causes in its input through a process of finding common spatial patterns and then finding common temporal patterns associated with the patient data. As the HTM is self trained, it will have parent/child relationships between each node, and is therefore able to handle time-varying data about a patient, and provides the ability to discover covert issues, which a clinician may not glean about the patient. The processing model may include other types of models, which may be used with or without the HTM model.

The processing model analyzes the patient data and performs a medical-risk assessment to determine whether the patient will experience a serious-medical event within a predefined period of time. This medical-risk assessment is then quantified as “a health-risk score.” In one embodiment, the health-risk score has a scale from 1 to 100, with a higher score indicative of a higher likelihood that the patient will experience a serious-medical event imminently, i.e., requiring a hospitalization. Correspondingly, a lower score indicates less likelihood that the patient will experience a serous-medical condition in the immediate future (e.g., 90 days), and the patient is considered more healthy. Other scales may be used as would be appreciated by those skilled in the art, after having the benefit of this disclosure. Also, the health-risk score is a quantified value that may change over time in response to observed changes in the health condition of the patient.

As mentioned above, the patient-management system also includes a front end for presenting patient data to users of the system such as a clinician. In one embodiment, the front end includes a user interface with at least one display region presenting the health-risk score of a patient. In another embodiment, the user interface generates a listing of patients ranked in ascending order according to their respective health-risk score. That is, a list of a clinician's patients may be displayed in ascending order, with those patients having a greater probability of experiencing a serious-medical event (e.g., those with higher scores) listed above those with lower-valued scores. An alert may also be sent to a clinician if the patient's health-risk score exceeds a predetermined threshold.

The list of patients may include all active patients in a particular clinician's practice, and/or those patients scheduled to be seen by the particular clinician during the day (or some other period of time).

In another embodiment, a user interface is generated that includes at least one display region containing a summary of the health status of a particular patient. The summary enables a clinician to initially acquaint himself with the most relevant information about the condition of a patient. For example, in one embodiment, the summary includes the most useful patient data for initially acquainting the clinician with the patient. In one embodiment, the summary includes the following information about a selected patient: personal information (e.g., name, sex, age, and ethnicity pf the patient), current condition (e.g. suffering from Asthma and congestive-heart failure), last hospitalization (e.g. date/hospital), current medications (e.g. drug, strength and remaining supply), results from a previous device interrogations, and laboratory results (e.g., normal potassium level, etc.).

If the clinician desires more detailed information about anyone of the items listed on the summary, the clinician may select (e.g. through a keystroke, or click of a mouse on a highlighted link) and then navigate to a more specific area of interest corresponding contextually to the topic of interest. For example, if the clinician desires to view the patient's lab results, the clinician can request that relevant content associated with laboratory data be retrieved from the staging database and be displayed to the clinician. The clinician can also select other topics of interest related to the patient.

In one embodiment, lab results may be displayed in one of several different desired formats selectable by the clinician. For example, the lab results may be viewed in chronological order enabling the clinician to view trends between successive lab reports (e.g. trended over time). In another embodiment, major differences between successive lab reports may be highlighted, which may be indicative of a positive or negative health factor impacting the health of the patient.

In still a further embodiment, clinicians in a practice group may navigate to an area and post notes in a collaborative fashion on issues impacting a particular patient. For example, a clinician may post a comment, a question, or an answer about a particular subject impacting the health of a patient. So, clinicians may analyze patient-specific issues in a collaborative fashion.

The foregoing summary provides an exemplary overview of one or more aspects of the invention. It is not intended to be extensive, or absolutely require any key/critical elements of the invention.

### BRIEF DESCRIPTION OF SEVERAL VIEWS OF THE DRAWINGS

The detailed description is explained with reference to the accompanying figures. In the figures, the left-most digit(s) of a reference number identifies the figure in which the reference number first appears.

FIG. 1 shows an exemplary patient-management system.

FIG. 2 illustrates an exemplary webpage for displaying a listing of patients ranked in ascending order according to their respective health-risk score.

FIG. 3 shows an exemplary webpage with contextual content appurtenant to a specific patient alert.

FIG. 4 shows an exemplary webpage, which includes contextual content associated with a summary of a patient's health status.

FIG. 5 shows an exemplary webpage with sample lab results populated therein.

FIG. 6A shows another exemplary webpage with notes posted by clinicians or other users of the system.

FIG. 6B shows another exemplary webpage with discussions and journals having content displayed therein that is relevant to a clinician's practice and/or conditions of his patients.

FIG. 7 illustrates an exemplary method for automatically monitoring a patient's health, predicting whether a serious-medical event will occur within a predetermined time period, and issue a health-risk score.

FIG. 8 illustrates an exemplary computing device.

### DETAILED DESCRIPTION OF THE INVENTION

Reference herein to “one embodiment”, “an embodiment”, or similar formulations herein, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

As used herein the following terms have the meaning that follows:

“Clinician” means a healthcare provider, such as, a physician, a doctor, a nurse, a physician's assistant, and other medical caregivers.

“Health-status information” means any information providing an indication of the present health condition of a patient, such as the patient's age, blood pressure, temperature, and physiologic state. Such information may also include results of tests, lab data, prescriptions, assessments, treatments, diagnosis, observations, and other indicators which may provide an indication of the overall health status of a patient.

“Patient data” means any data or information pertaining to a patient's health such as medications, diagnosis, treatments, conditions, laboratory results, physiologic data, personal data, and device data.

“Serious-medical event” means events or health episodes that are likely to lead to a patient being hospitalized. Examples of a serious-medical event include, but are not limited to, heart attacks, strokes, pneumonia, death, and infections.

“Medical-record website” means a website that includes a collection of web pages, images, videos, content or other digital assets directed to patient data, medical information, and social forums, hosted on one or several Web server(s), usually accessible to users or members of the site via the internet, or some other network.

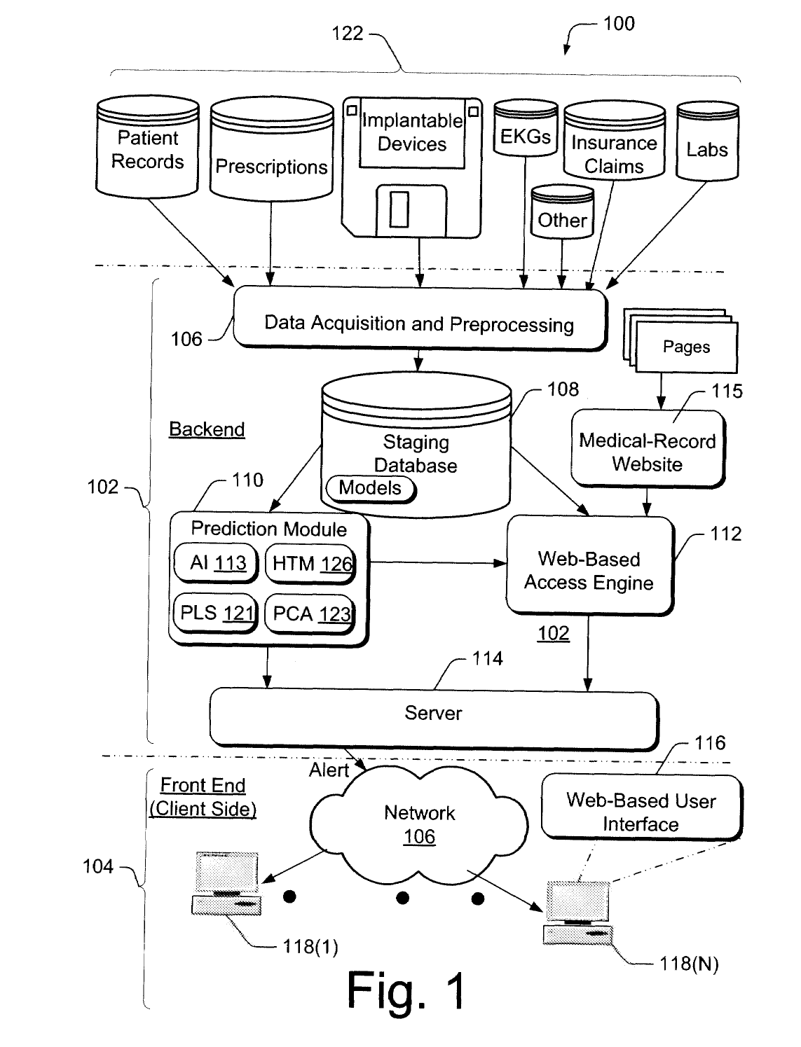

Referring initially to FIG. 1, in one embodiment, a patient-management system 100 includes a backend 102 and a front end 104. Backend 102 of system 100 automatically tracks patient data, and predicts whether the patient will experience a serious-medical event within a predetermined time period. Front end 104 of system 100 presents health-status information about a patient to users of the system, including any predictions of a serious-medical event within a predefined time period.

Patient-management system 100 may be implemented in various forms of hardware, software, firmware, special-purpose processors, or a combination thereof. For example, many of the modules in background 102 are implemented in software (code) that are embodied in storage devices (e.g., hard disk, RAM, ROM, DVD, flash or other memory devices) and executable by a processor operating as part of any suitable machine, such as server 114 (or servers).

As appreciated by those skilled in the art having the benefit of this disclosure, because the constituent-system modules and methods performed by each module, may be implemented in software, the actual connections between the system components depicted in FIG. 1, as well as the exact order of operations, may differ depending on the manner in which modules are programmed.

Backend 102 of system 100 includes a data-acquisition-and-preprocessing module 106, a staging database 108, a prediction module 110, a web-based-access module 112, and a server 114. Maintained on database 108 on some type of storage mediums (not shown) local or remote to server 114, is a medical-record website 115.

Referring to each of the modules in more detail, data-acquisition-and-preprocessing module 106 obtains clinical data from one or more data sources 122 (e.g., patient records, prescriptions, insurance records, implantable devices, EKGs, insurance claims, dictated reports, diagnostic reports, laboratory results, and other clinical data). Data-acquisition-and-preprocessing module 106 reformats the data into a common format, referred to herein as normalization. The common format may facilitate a unified display of information. The reformatted data is then submitted to a staging database 108. Certain types of data, such as analog printouts of device data such as EKGs or implantable devices, may be extracted and formatted into digital formats for storage by data-acquisition-and-preprocessing module 106.

For example, data-acquisition-and-preprocessing module 106 is configured to read data from implantable-device floppies (such as pacemakers), parse the data, and save the data to staging database 108. An example of such a technique is described in one or more of the commonly owned U.S. Patent Applications listed below.

Data-acquisition-and-preprocessing module 106 may also utilize code configured to perform text mining, to extract relevant data from a patient's records, such as reports, diagnosis, etc. Such data may be located in unformatted fields. Values may be assigned to the text to help determine the variable and value.

Data-acquisition-and-preprocessing module 106 may also be configured to store data in staging database 108 in a format that is in compliance with the Health Insurance Portability and Accountability Act (HIPAA) regulations. For instance, all information that might identify a patient (name, social security number) may be removed from records before being stored. To ensure the ability to accurately track the data in staging database 108, the data may be linked together by identification tags. Private data may be re-linked with the de-identified data upon being accessed for dissemination to a clinician.

Staging database 108 is a central repository for patient data in a normalized format. Staging database 108 supports device-independent data exchange with other devices such as server 114, prediction module 110, and web-based-access module 112. As the data stored within staging database 108 is normalized, the data may be processed and accessed without the need for further conversion. Data is typically segregated on a per-patient basis in data base 108, and linked with clinicians or other health-care providers having access to the patient's data.

While staging database 108 is depicted as a being resident in a memory medium in server 114, it is appreciated by those skilled in the art that data contained in staging database 108 may be distributed among several media, including external storage remote from server 114. Although staging database 108 is depicted as single repository, it is understood by those skilled in the art, that it may include several databases across one or many database servers.

Staging database 108 may be configured in a variety of suitable formats. For instance, database 108 may include hierarchical and relational models, combinations thereof, and other suitable formats as would be appreciated by those skilled in the art. Also, as appreciated by those skilled in the art, any suitable language such as SQL (Structured Query Language) may be used to build, modify, and query the staging database 108.

Prediction module 110 is configured to continually analyze patient data in staging database 108, and automatically predict when a patient will likely experience a serious-medical event in a predetermined time period. That is, prediction module analyzes patient data and performs a medical-risk assessment to determine whether a patient will experience a serious-medical event within a predefined period of time such as 90 days or longer or shorter periods of time. This medical-risk assessment is then quantified as “a health-risk score.”

In one embodiment, the health-risk score has a scale from 1 to 100, with a higher score indicative of a greater likelihood that the patient will experience a serious-medical event imminently, i.e., requiring a hospitalization. Correspondingly, a lower score indicates less likelihood that the patient will experience a serious-medical condition in the immediate future (e.g., 90 days), and the patient is considered more healthy. Other scales may be used as would be appreciated by those skilled in the art, after having the benefit of this disclosure. Also, the health-risk score is a quantified value that may change over time in response to observed changes in the health condition of the patient.

Prediction module 110 may use several different analytical models to arrive at a “health-risk score.” The models may include a simple rule-based model 111 that relies on one or more knowledge bases that contain sets of data that form rules. For example, persons over X weight with Y Cholesterol, are assigned into a Z risk category, and assigned a score. A higher ranking is assigned to those attributes considered to be less healthy, such as elevated LDL levels. A lower ranking is assigned to those attributes which were considered normal LDL levels. As appreciated by those skilled in the art having the benefit of this disclosure, the knowledge base may be configured to include various suitable structures and classification schemes.

Prediction module 110 may also include more sophisticated models, and knowledge bases. For instance, in one embodiment, prediction module 110 may use an artificial-intelligence component 113. Such a model may be capable of learning from experience, and assign scores, based on risk associated with different factors.

In one embodiment, prediction module 110 may also use partial-least squares analysis (PLS) module 121, which is suited to analyzing time-varying data for patients to score the current health status of the patient. PLS module 121 is used for predictions associated with a serious-medical event. PLS module 121 may be used with a principal component analysis (PCA) module 123 configured to reduce multidimensional data sets to lower dimensions for analysis, e.g. used for classifications. Both modules track the health of the patient to produce a dynamic health-risk score, which if high enough, is a prediction of a serious-medical event in the near future. An example of such a technique is described in one or more of the commonly owned U.S. Patent Applications listed below.

In one embodiment, prediction module 110 may also include a Hierarchical Temporal Memory (HTM) module 126 to predict a serious-medical event within a month and possibly weeks or days. The HTM module 126 draws upon data from staging database 108, which will be up to date on a daily basis. HTM allows spatial and temporal-pattern recognition. Spatially, this will allow the identification of data patterns that put patients at risk due to common symptoms for a serious-medical event for the entire patient population. Temporally, an individual patient's data can be analyzed over time to identify patterns which indicate a risk of hospitalization. Data regarding the observed patterns and/or sequences are passed to a parent module (inherent in HTM networks) which provides feedback to a child module. Thus, HTM module 126 includes HTM networks that can predict when a patient is at risk of an impending hospitalization, i.e., a serious-medical event.

HTM networks use both time and spatial information about the prediction of serious-medical event. HTM module 126 may process spatial and temporal relationships which is important to identify known patterns of data which predict a serious-medical event. It is also possible through the use of the inherent hierarchy of the HTM network to discover and identify some higher-level generalizations regarding how the different types of input data interact. An example of such a technique is described in one or more of the commonly owned U.S. Patent Applications listed below.

To the extent there is more than one model, prediction module 110 aggregates data and/or scores produced by each model, to arrive at a health-risk score for a patient, which is stored in staging base 108 for retrieval by web-based access module 112. As may be appreciated by those skilled in the art, after having the benefit of this disclosure, aggregation may involve any suitable calculation algorithm. For instance, in one embodiment aggregation may involve simply adding individual scores from different modules corresponding to health factors that are weighted in terms of believed importance in predicting health. In another embodiment, scores may be added and averaged against each other to arrive at a single score, which may involve calculating standard error differences, and so forth.

Web-based access module 112 is configured to access patient data stored in staging database 108, including health-risk scores of patients as determined by prediction module 110. Web-based access module 112 can access patient data in response to commands received by server 114 from one or more users on the client side, such as populating fields in pages of a medical-record website. As appreciated by those skilled in the art, a client-server framework as depicted in FIG. 1, may be implemented using any suitable computing environment framework such as peer-to-peer, or master/slave, for example.

Front end 104 includes a web-based user interface 116 that generates content on a graphical-user interface from medical-record website 115 based on communications between server 114 and client-side computers 118. One or more users of medical-record website 115 may connect to server 114 via a network 120 (such as the Internet) and the user's client-side computers 118(1), . . . , 118(N). Network 120 may comprise any suitable network configuration such as an intranet, a local-area network (LAN), the internet, a wireless communication, a virtual-private network (VPN), and so forth.

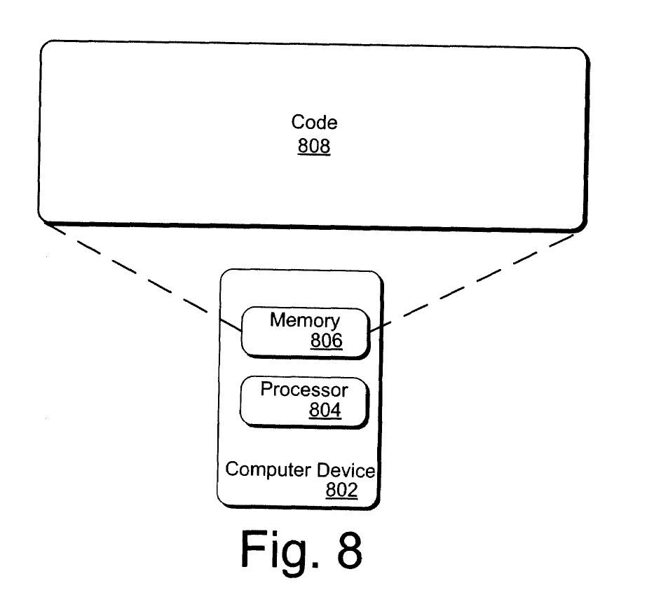

As appreciated by those skilled in the art, server 114 and client-side computers 118 may be implemented as any suitable computer processing system, such as the representative computing device shown in FIG. 8 (described below). Also, as appreciated by those skilled in the art, server 114 and client-side computers 118 may utilize any suitable combination of communication protocols and computer-program applications (code) to communicate with each other, such as, but not necessarily limited to Hypertext Transfer Protocol (HTTP), Transmission Control Protocol/Internet Protocol (TCP/IP), Wireless Application Protocol (WAP), and a myriad of other protocols/applications.

In one possible embodiment, medical-record website 115 is hosted by server 114. Medical-record website 115 includes a collection of related data, pages, files, etc. relating to patient data and other related information. Server 114 transmits the collection of data from site 115 to a user/member via their client-side computer 118 (and via network 120), based upon requests made by the client-side computer 118. For example, a user may request a web page (example to be described), that is displayed on a client-side computer 118. Typically, medical-record website 115 includes a “home page,” which usually serves as the first and main page to any website, as is well known to those skilled in the art.

While the embodiment depicted in FIG. 1 illustrates a single server 114, those skilled in the art will appreciate that website 115, staging database 108, and any of the modules depicted therein may be distributed over network 120 on different host machines. Those skilled in the art after having the benefit of this disclosure, should also readily envision other architectures for implementing system 100.

Before describing particular screen shots of front end 104, it is presumed that any user that is able to log into website 115 has a valid clinical relationship with the patient, or is the patient. Security parameters may be deployed to prevent unapproved access to patient data, such as, for illustrative purposes only, passwords, pins, keys, etc.

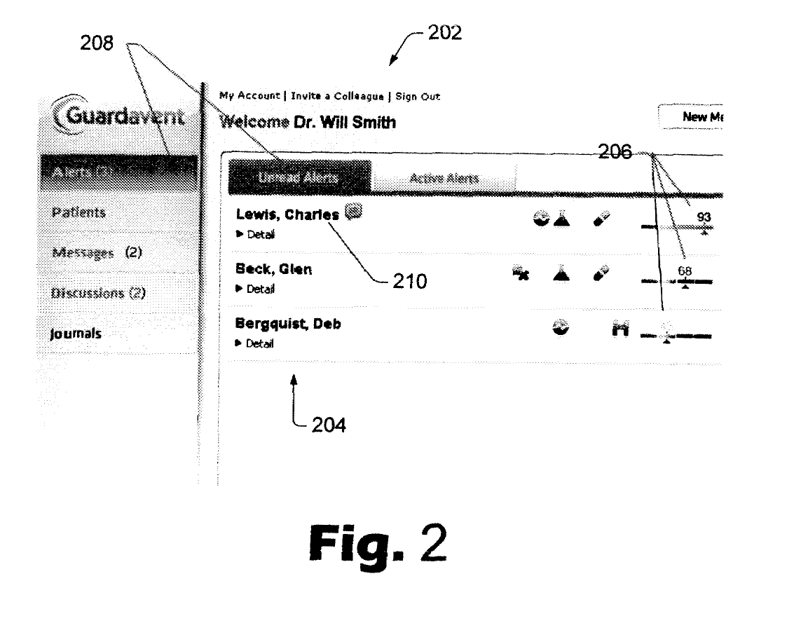

As mentioned above, front end 104 presents patient data to users of system 100. In one embodiment, front end 104 includes a user interface 116 with at least one display region presenting the health-risk score of a patient. For example, FIG. 2 illustrates a webpage 202, which is rendered on a client-side computer 108 within user interface 116. Webpage 202 presents a listing 204 of patients ranked in ascending order according to their respective health-risk score 206. That is, a list 204 of a clinician's patients may be displayed in ascending order, with those patients having a greater probability of experiencing a serious-medical event (e.g., those with higher scores 206) placed above those with lower-valued scores. The list of patients may include all active patients in a particular clinician's practice, and/or those patients scheduled to be seen by the particular clinician during the day (or some other period of time), such as those scheduled for an appointment.

As appreciated by those skilled in the art, other suitable content may be included on page 202, or on other display screens/pages. Accordingly, some or all of the icons may be displayed in different formats, in different pages, in different order, in different colors, in different highlights, in different font, with different verbiage, etc.; and page 202 is only illustrated as one exemplary implementation.

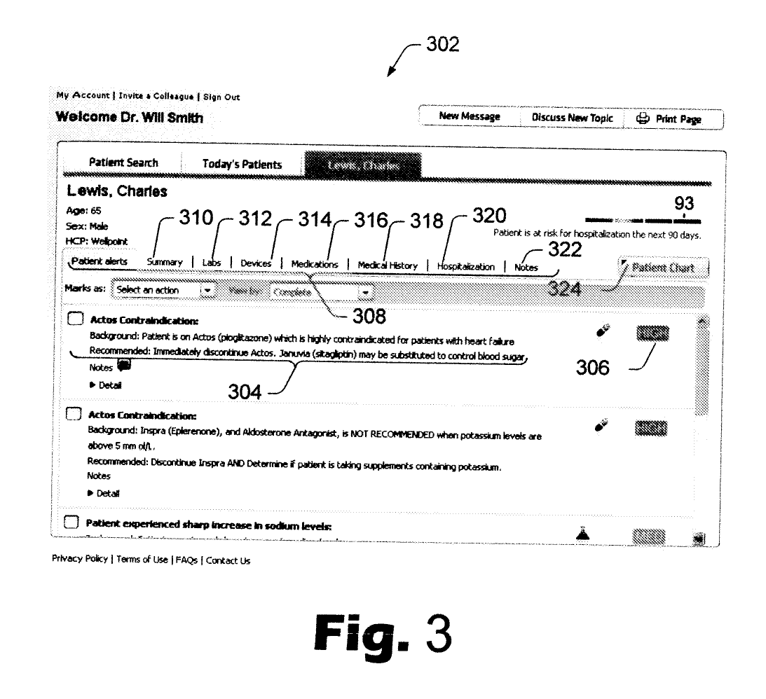

In one embodiment, list 204 is rendered as part of “alerts” section 208 of website 115 (FIG. 1). To find further details about a particular patient's condition, a clinician may click on hypertext link 210 embedded in the text portion of the patient's name. This will lead the user to contextual information providing more definitive reasoning for issuing the alert. So, supposing a user selects a particular patient in FIG. 2, such as the patient associated with hyperlink 210, then a new webpage 302 (FIG. 3) is displayed on a user's client-side computer 118. Exemplary webpage 302 includes contextual content 304 associated with the alert. Also shown is a risk level value “high” 306 associated with alert, indicating that the alert is potentially of a life-threatening nature or one having a significant-negative-health impact. In one embodiment, three levels of risks are possible, high (1), medium (2), or low (3). However, as appreciated by those skilled in the art having the benefit of this disclosure, other risk-level values may be used to denote a risk level, including a numeric value, different colors, flashing text or symbols, sound and/or any combination of alerts. The alerts may be more or less specific in terms of contextual detail.

Also shown on webpage 302 are hypertext icons 308 on which the user can select, (e.g., click) and be directed to another webpage with related information. In one embodiment, hypertext icons 308 include: summary icon 310, labs icon 312, devices icon 314, medications icon 316, medical history icon 318, hospitalization icon 320, and notes icon 322. The clinician may also view the patient's chart, by selecting patient's chart icon 324. As appreciated by those skilled in the art, other suitable textual or graphical information may be incorporated or displayed on webpage 302.

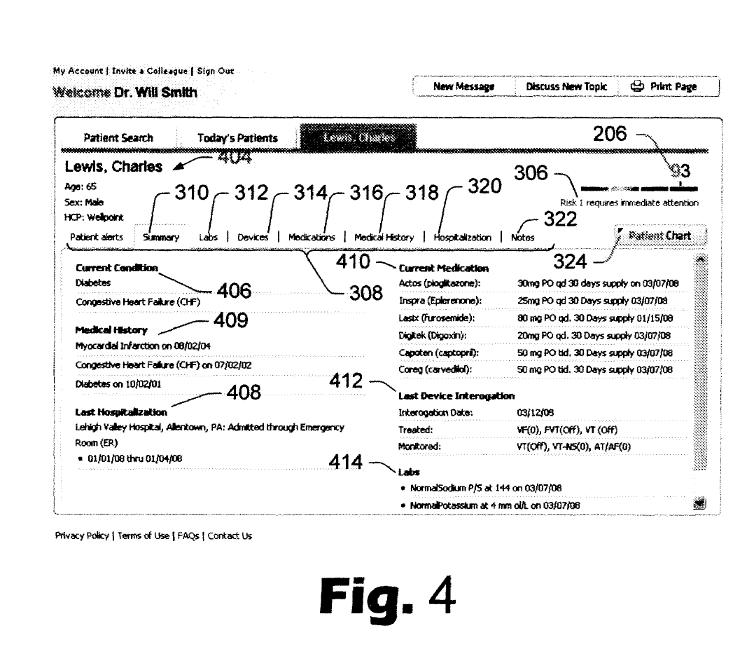

Suppose a user selects summary icon 310. Then a new webpage 402 (FIG. 4) is displayed on a user's client-side computer 108. Exemplary webpage 402 includes contextual content 404 associated with summary of the patient's health status. Specifically, a user interface (e.g., webpage 402) is generated that includes at least one display region containing a summary of the health status of a particular patient. The summary enables a clinician to initially acquaint himself with the most relevant information about the condition of a patient, and essentially becoming an instant expert of the patient's health.

For example, in one embodiment, the summary page includes the most useful patient data for initially acquainting the clinician with the patient. In one embodiment, the summary includes the following information about a selected patient: personal information 404 (e.g., name, sex, age, and ethnicity pf the patient), current condition 406 (e.g. suffering from Asthma and congestive-heart failure), last hospitalization 408 (e.g. date/hospital), major-medical history 409 (e.g. heart attack in 2001); current medications 410 (e.g. drug, strength and remaining supply), results from a previous device interrogations 412, and laboratory results 414 (e.g., normal potassium level, etc.). As appreciated by those skilled in the art, other suitable textual or graphical information may be incorporated or displayed on summary page 402.

If the clinician desires more detailed information about anyone of the items listed on summary page 402, the clinician may select (e.g. keystroke, or click of a mouse on a highlighted link) and then navigate to a more specific area of interest corresponding contextually to the topic of interest. For example, if the clinician desires to view the patient's lab results by clicking on labs icon 414, the clinician can request that relevant content associated with laboratory data be retrieved from staging database 108 (FIG. 1) and be displayed to the clinician. The clinician can also select other topics of interest related to the patient.

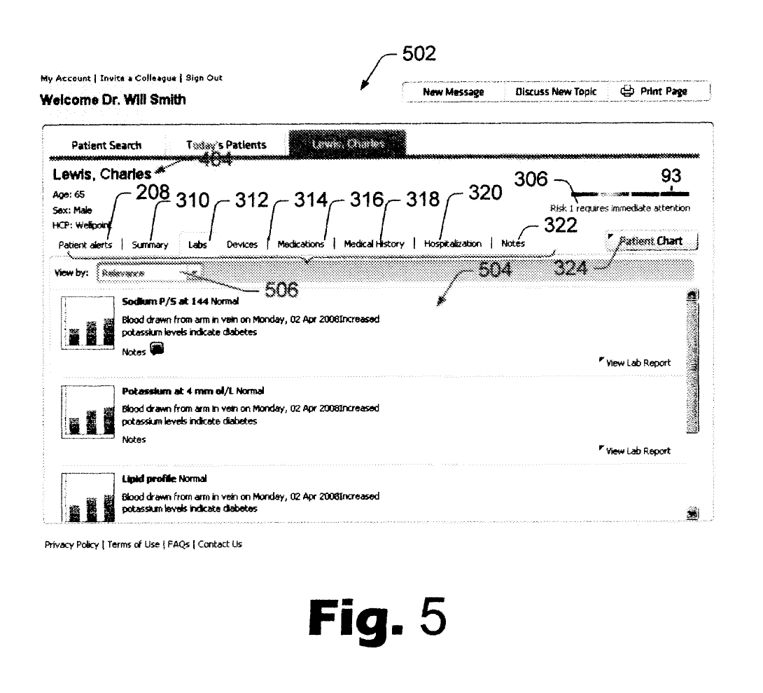

FIG. 5 shows one exemplary webpage 502 with lab results 504 therein. As depicted in FIG. 5, lab results may be displayed in one of several different desired formats selectable by the clinician by clicking on the drop-down menu 506. For example, the lab results may be viewed in chronological order (by date) enabling the clinician to view trends between successive lab reports. In another embodiment, major differences between successive lab reports may be viewed (e.g., relevance), which may be indicative of a positive or negative health factor impacting the health of the patient. In another embodiment, the lab reports may be displayed in other order, such as topical-alphabetical order. As appreciated by those skilled in the art, other suitable textual or graphical information may be used to display lab information.

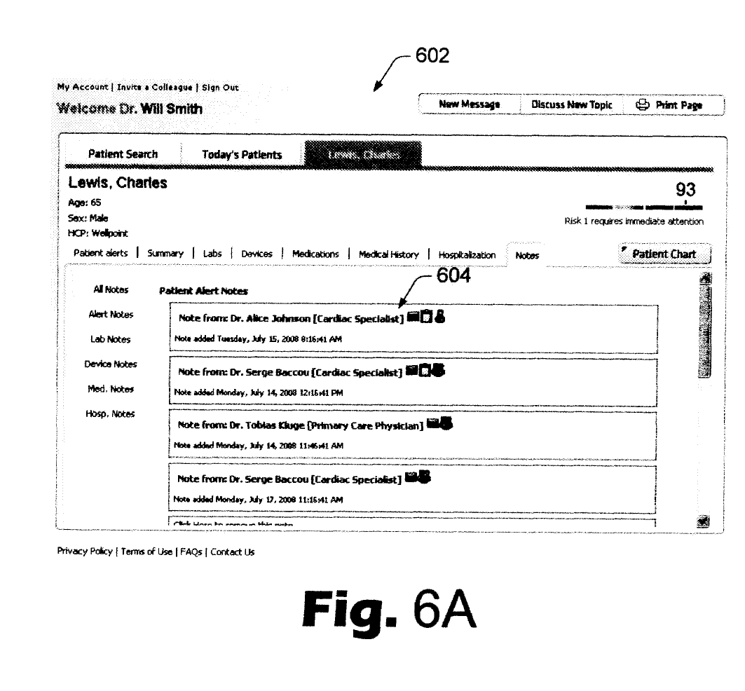

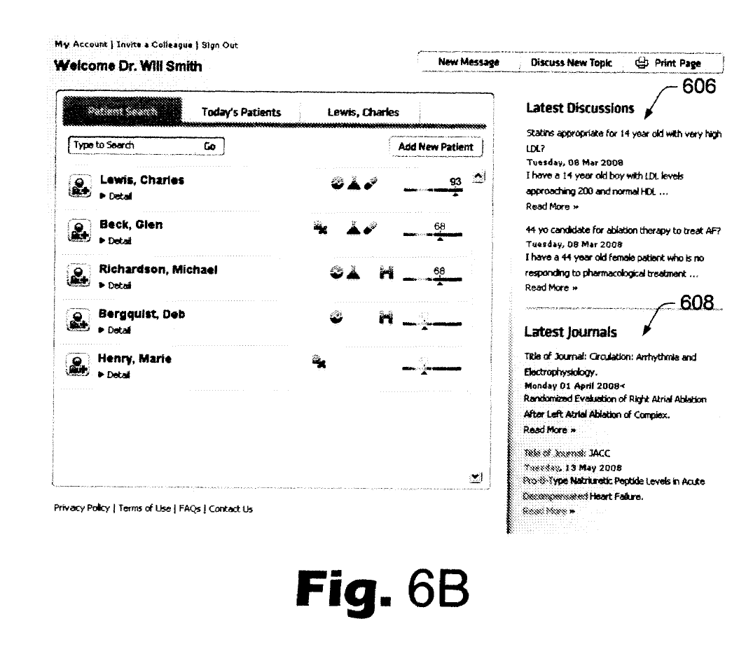

FIG. 6A shows another exemplary webpage 602 with notes—tied to a patient's record—posted by clinicians or other users of system 100. In one embodiment, clinicians in a practice group may navigate to webpage 602 and post notes 604 in a collaborative fashion on issues impacting a particular patient. For example, a clinician may post a comment, a question, or an answer about a particular subject impacting the health of a patient. So, clinicians may analyze patient-specific issues in a collaborative fashion. It is possible for notes to be displayed or posted according to a one or more categories or subcategories of issues. Each comment or question, are available for display as part of the content area of the category (e.g., labs, medicines, etc.) and/or aggregated together as a list in one or more areas of website 115. These notes may be visible to other practice groups or restricted to a limited set of one or more clinicians. That is, the discussion forum may be private, and only accessible by a user of site 115, semi-private, or publicly viewable.

Another aspect of site 115 includes the ability of users to receive messages, or postings via a discussion forum, shown as 606 in FIG. 6B. In one exemplary embodiment, the discussion forum is private, and is only available to registered clinicians of exemplary site 115. The discussion forum is intended to promote intra-site communication. These discussions 606 and postings may be tied back, and linked to a particular patient record. That is, the forums may be contextually mined for specific information that may be fed back to a patient's record based on the patient's condition.

Additionally, in other embodiment, journal articles may be mined contextually for subjects related to a patient's condition, and displayed on a portion of a webpage associated with a patient's record, such as shown in display area 608 (FIG. 6B). For instance, for a patient suffering from heart failure, journal articles may be automatically searched for information pertaining to heart failure. Each article located may be and displayed in order of relevance or by date.

To increase the potential the information will assist the clinician, relevant content may be delivered from a subset of publications, such as peer-reviewed journals. A summary of the source, date of publication, and the first 10 to 20 words of the title may be displayed. On mouse over, the first 100 words or so of the abstract may be displayed. If an abstract is not available, the first 100 words of the article may be displayed in its place. The user can then click the summary or abstract to launch the article. Content from journals can also be personalized for delivery by mining data about the clinician, his patients, and other relevant sources to deliver content of the greatest value to the clinician. For example, a cardiologist or electrophysiologist might see articles pulled from JACC, AHA Journal, NEJM, etc. Specific articles might be selected by mining patient data for conditions, drug prescriptions, implanted device brands and types, demographics, etc. The new content will then be ranked and delivered with the highest ranking articles appearing on the top of the list. The ranking is based on a number of factors including the age of article, h-index of author, Thomas Science Hot Papers ranking, and other popularity and impact rankings. Even a popular article will fall from the top over time as its age causes it to decrease in the overall ranking.

In one embodiment, medical-discussion forums and/or medical journals are mined for content relevant to a patient's health condition, based on contextual data associated with the patient's health condition, and/or associated with a practice of a clinician; and a display is generated of at least a portion of the content on a webpage associated with the patient and/or the clinician, such as shown in FIG. 6B.

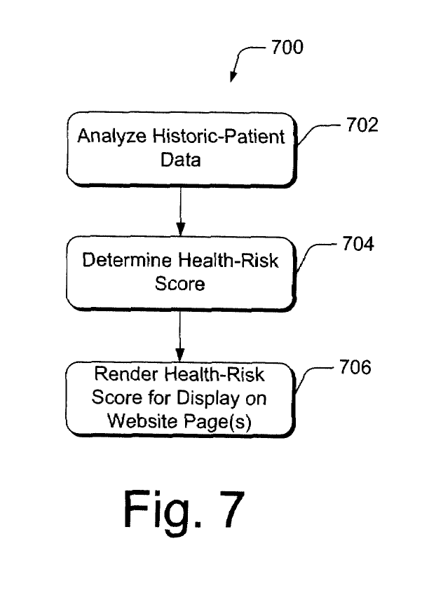

FIG. 7 illustrates an exemplary method 700 for automatically monitoring a patient's health, predicting whether a serious-medical event will occur within a predetermined time period, and issuing a health-risk score based on the prediction, wherein the health-risk score is indicative of the likelihood that the patient will experience a serious-medical event in the near future (predetermined time period, e.g., two weeks, 60 days, 90 days, etc.). So, the clinician is able to reach out to the patient in a preventative manner before the serious-medical event occurs, rather than having to react to the patient after the patient experiences the serious-medical event.

Method 700 includes blocks 702, 704, and 706 (each of the blocks represents one or more operational acts). The order in which the method is described is not to be construed as a limitation, and any number of the described method blocks can be combined in any order to implement the method. Furthermore, the method can be implemented in any suitable hardware, software, firmware, or combination thereof. Additionally, although each module in FIG. 7 is shown as a single block, it is understood that when actually implemented in the form of computer-executable instructions, logic, firmware, and/or hardware, that the functionality described with reference to it may not exist as separate identifiable block.

Referring to FIG. 7, in block 702 a patient's health is automatically monitored by analyzing historic-patient data (i.e., performing a medical-risk assessment) to determine whether a particular patient will experience a serious-medical event within a predefined period of time. For example, by way of illustration and not as limitation, prediction module 110 (FIG. 1) assesses diagnostic, laboratory, pharmacological, physiological, device data, age, weight, ethnicity, gender, and other suitable patient data.

In block 704, “a health-risk score” is determined providing a probability that the patient will experience a serious-medical event within a predetermined time period, based on the assessment of the historic-patient data performed in block 702. A poor health-risk score indicates a high risk of the patient experiencing serious-medical event during the predetermined period. As a result a clinician should take proactive steps to prevent the event from occurring, or at least reduce the severity of the medical event. For example, in one embodiment, by way of illustration and not as limitation, prediction module 110 (FIG. 1) generates one or more values that correlate to the health of the patient. These values are aggregated to produce one or more health-risk scores. In one embodiment, the health-risk score is generated from a scale of possible scores such as from 1 to 100. A higher score is indicative of a higher probability that the patient will experience a serious-medical event imminently, i.e., requiring a hospitalization. On the other hand, a lower score is indicative that there is a less likely probability that the patient will experience a serous-medical condition in the immediate future (e.g., 90 days), and therefore, the patient is considered more stable or healthy. Other scales may be used as would be appreciated by those skilled in the art, after having the benefit of this disclosure. response to observed changes in the health condition of the patient. Furthermore, the health-risk score may be quantified by color, shapes, symbols, scales, alphabetical information, sound, alerts, other indicia, and/or any combination of the foregoing.

In one embodiment, the predetermined period of time may be adjustable. For example, a user may have the ability to modify the amount (greater or lesser) of time for which to perform the prediction.

In block 706, the health-risk score is generated (issued) for transmission and display to an end user. Alternatively, in another embodiment, a contextual alert can also be automatically generated and sent to a clinician associated with site 115, when a particular patient is presently at risk for experiencing a serious-medical event imminently. In one embodiment, operations performed in blocks 702, 704, and 706 are on a continuous basis and the health-risk score is updated upon receiving new and updated patient data, or over time.

Although various embodiments have been described above with reference to flowcharts and/or block diagrams, it is appreciated by those skilled in the art, after having the benefit of this disclosure that any blocks or functionality described therein may be implemented in code executed by a processor.

FIG. 8 illustrates an exemplary computing device 802, which may be representative of server 114 or client-side computer 118. Generally, these devices may be any of a variety of computer devices, including desktop PCs, servers, mainframes, workstations, notebook or laptop computers, hand held or portable PCs, personal digital assistants (PDAs), cellular phones, Internet appliances, gaming consoles, portable communication devices, televisions/set-top boxes, wireless devices, multiprocessor systems, microprocessor systems, programmable consumer electronics, multimedia systems, a combination of any of the above example devices, and other smart devices.

Computing device 802 includes at least one processor 804 and memory 806. Memory 806 may include volatile memory (e.g., RAM) and/or non-volatile memory (e.g., ROM, PCMCIA cards, etc.). In some implementations, memory 806 is used as part of a computer's cache, permitting application data to be accessed quickly without having to permanently store data in a non-volatile memory device.

Resident in the memory 806 are one or more operating systems (not shown), and code 808 that executes on processor 804. For purposes of illustration, programs and other executable program modules are illustrated herein as discrete blocks, although it is recognized that such programs and components reside at various times in different storage components of device 802, and are executed by the one or more processors.

Other elements such as power supplies, keyboards, touch pads, I/O interfaces, displays, LEDs, audio generators, vibrating devices, and so forth are not shown as being a part of device 802, but could easily be a part of any such device. Additionally, although not shown, a system bus or point-to-point connections typically connects the various components within device 802. It is noted that computer-executable instructions (code) may be located in both local and remote computer storage media, including memory storage devices (computer-readable media).

The following co-pending, and commonly-assigned patent applications are incorporated by reference as if fully disclosed herein:

U.S. patent application Ser. No. 11/938,409, filed on Nov. 11, 2007, entitled Method and System for Active Patient Management;

U.S. patent application Ser. No. 12/284,999, filed on Sep. 25, 2008, entitled Method for Detecting Bio Signal Features in the Presence of Noise;

U.S. patent application Ser. No. 12/284,932, filed on Sep. 25, 2008, entitled Method for Reducing Baseline Drift in a Biological Signal;

U.S. patent application Ser. No. 12/284,976, filed Sep. 25, 2008, entitled System and Method for Predicting Rare Events;

U.S. patent application Ser. No. 12/284,943, filed Sep. 25, 2008, entitled System and Method for Using Classification Trees to Predict Rare Events;

U.S. patent application Ser. No. 12/284,929, filed Sep. 25, 2008, entitled Predicting Rare Events Using Principal Component Analysis and Partial Least Squares;

U.S. patent application Ser. No. 12/284,931, filed Sep. 25, 2008, entitled Method and System for Archiving Biomedical Data Generated by a Data Collection Device;

U.S. patent application Ser. No. 12/284,944 filed Sep. 25, 2008, entitled Methods for Storing Data; and

U.S. patent application Ser. No. 12/284,930, filed Sep. 25, 2008, entitled Method for Extracting Waveform Attributes from Biological Signals.

The embodiments described herein are to be considered in all respects only as exemplary and not restrictive. The scope of the invention is, therefore, indicated by the subjoined Claims rather by the foregoing description. All changes which come within the meaning and range of equivalency of the Claims are to be embraced within their scope.

1. A computer-implemented method for automatically monitoring a patient's health, and reporting patient information to clinicians, comprising:
analyzing historic data indicative of a patient's health condition from a database;
determining a risk factor that a patient will experience a serious-medical event within a predetermined period of time based on the assessment; and
generating a user interface having (i) a display region in which the risk factor, and (ii) a synopsis of the patient's health condition is displayed, whereby the risk factor coupled with the synopsis enables a clinician to grasp a patient's most critical health parameters when viewing the display region.

2. The method as recited in claim 1, further comprising: using a Hierarchical-Temporal Memory (HTM) model, in part, to analyze the historic data and determine the risk factor.

3. The method as recited in claim 1, wherein the display region includes at least the following health-status information:
(a) personal information about the patient including a name, sex, and age of the patient;
(b) a current condition of the patient;
(c) a history listing of major-medical events; and
(d) a listing of current medications.

4. The method as recited in claim 3, wherein the display region further includes at least one of (e) past-laboratory results, and (f) a result from a previous device interrogation.

5. The method as recited in claim 1, further comprising: displaying one or more portions of the patient's health condition on a web-based discussion forum wherein clinicians are prompted to post questions and discuss issues relevant to the patient's health condition.

6. The method as recited in claim 1, further comprising: mining medical-discussion forums for content relevant to a patient's health condition, based on contextual data associated with the patient's health condition, and/or based on data associated with a practice of a clinician; and generating a user interface having a second-display region containing at least a portion of the content associated with the patient and/or the clinician.

7. The method as recited in claim 1, further comprising: mining medical journals for content relevant to a patient's health condition, based on contextual data associated with the patient's health condition, and/or based on contextual data associated with a practice of a clinician; and generating a user interface having a second-display region containing of at least a portion of the content associated with the patient and/or the clinician.

8. The method as recited in claim 1, wherein the risk factor is a scaled-numerical value.

9. A computer-implemented method for automatically monitoring a patient's health, and reporting patient information to clinicians, comprising:
analyzing historic data indicative of a patient's health condition from a database;
predicting whether a patient will experience a serious-medical event within a predetermined-time period;
generating a health-risk score based on the prediction, wherein the health-risk score is indicative of the likelihood that the patient will experience the serious-medical event within the predetermined-time period; and
generating a user interface having (i) a display region in which the health-risk score, and (ii) a synopsis of the patient's health condition is displayed, wherein the synopsis includes: a present condition, a last hospitalization, a present medication, and a laboratory result about the patient, whereby the health-risk score coupled with the synopsis enables a clinician to grasp a patient's most critical health parameters when viewing the display region.

10. The method as recited in claim 9, further comprising transmitting the health-risk score to a clinician.

11. The method as recited in claim 9, further comprising rendering a webpage containing at least one section with a patient name and their respective health-risk score.

12. The method as recited in claim 9, further comprising using, a Hierarchical-Temporal Memory (HTM) model, in part, to analyze historic data about the patient and determine the health-risk score.

13. The method as recited in claim 9, further comprising generating the health-risk score and an integrated synopsis of the patient's health condition for display on a webpage including generating a display region containing at least the following:
(a) personal information about the patient including at least a name, sex, and age of the patient;
(b) a current condition of the patient;
(c) a history listing of major-medical events; and
(d) a listing of current medications.

14. The method as recited in claim 9, further comprising: displaying one or more portions of a patient's health condition on a web-based discussion forum wherein clinicians are prompted to post questions and discuss issues relevant to a health condition of the patient.

15. One or more computer-readable media having computer-readable instructions thereon which, when executed by the one or more processors, cause a computer device to:
generate a user interface that includes at least one display region containing a summary of a health status of a particular patient, wherein the summary includes at least one of the following about the patient: a present condition, a last hospitalization, a present medication, and a laboratory result;
predict whether the patient will experience a serious-medical event within a predetermined-time period;
generate a health-risk score based on the prediction, wherein the health-risk score is indicative of the likelihood that the patient will experience the serious-medical within the predetermined-time period; and
include the health-risk score as data within the generated user interface.

16. The computer-readable media of claim 15, further having computer-readable instructions thereon which, when executed by the one or more processors, cause a computer device to: mine medical-discussion forums for content relevant to a patient's health condition, based on contextual data associated with the patient's health condition, and/or based on data associated with a practice of a clinician; and generating a display of at least a portion of the content associated with the patient and/or the clinician.

17. The computer-readable media of claim 15, further having computer-readable instructions thereon which, when executed by the one or more processors, cause a computer device to: mine medical journals for content relevant to a patient's health condition, based on contextual data associated with the patient's health condition, and/or based on data associated with a practice of a clinician; and generating a display of at least a portion of the content associated with the patient and/or the clinician.

18. The computer-readable media of claim 15, further having computer-readable instructions thereon which, when executed by the one or more processors, cause a computer device to: process data about the patient using a Hierarchical-Temporal Memory (HTM) model, to generate the health-risk score.

19. A patient-management system for tracking a patient's health, and reporting patient information to clinicians, comprising:
a memory for storing computer readable code; and a processor operatively coupled to the memory that, upon executing the computer readable code, is configured to:
analyzing health-status information associated with a patient;
determining a risk factor that a patient will experience a serious-medical event within a predetermined period of time based on the analysis; and
generating a user interface having (i) a display region in which the risk factor, and (ii) an integrated synopsis of the patient's health condition is displayed, whereby the risk factor coupled with the synopsis enables a clinician to view a patient's most critical health parameters in a single display region.
